(19) United States
(12) Patent Application Publication
(10) Pub. No.: US 2016/0117682 A1
(43) Pub. Date: Apr. 28, 2016

(54) SECURE SEAMLESS PAYMENTS

(71) Applicant: EBAY INC., San Jose, CA (US)

(72) Inventors: Badrinath Vengalathur Srinath, Chennai (IN); Jigar Surana, Chennai (IN)

(21) Appl. No.: 14/526,420

(22) Filed: Oct. 28, 2014

(51) Int. Cl. G06Q 20/40

(52) U.S. Cl. CPC G06Q 20/40145

(57) ABSTRACT

Methods and systems for facilitating payment are described. A user creates a user profile with a service provider, and the user profile is stored locally on a user device. When the user wants to make a payment from the user device, software running in the background of the device determines that a user profile is stored on the user device. If a user profile is detected, the software automatically presents the user with an option to make a payment with one or more funding sources. User credentials in the user profile are used to authenticate the user and authorize payment.

### BACKGROUND

1. Field of the Invention

The present invention generally relates to facilitating payment, and more particularly to using a stored user profile on a device to facilitate a payment.

2. Related Art

In online financial transactions, users typically search for and purchase products and services through electronic communications with online merchants over electronic networks, such as the Internet. During the course of these transactions, users may provide payment in various ways including, for example, credit cards, electronic fund transfers, and other payment techniques offered by payment providers.

Most online shopping carts redirect users to payment gateways to complete the payment process securely. These gateways typically request users to enter their username and password to authenticate the payment. This process can be tedious and inconvenient. Entering information every time an online transaction takes place is inefficient and time consuming. Thus, there exists a need to improve the process of purchasing products and services in online transactions.

### BRIEF DESCRIPTION OF THE FIGURES

FIG. 1 is a block diagram illustrating a system for facilitating payment according to an embodiment of the present disclosure;

FIG. 2 is a block diagram illustrating a user device according to an embodiment of the present disclosure.

FIG. 3 is a flowchart showing a method for facilitating payment according to an embodiment of the present disclosure;

FIGS. 4A-4C are screenshots of an interface that is displayed to a user during user registration for secure seamless payments according to an embodiment of the present disclosure;

FIGS. 5A-5D are screenshots of an interface that is displayed to a user during purchase and checkout according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that facilitate payment. When a user wants to make a payment from a user device (e.g., a mobile phone), software on the device determines that a user profile is stored on the device, which enables secure seamless payments. The user profile was previously created and stored when the user logged into a service provider website. In certain embodiments, the user profile is stored on the device as a token. The token contains at least the username and password of the user, and allows the service provider to recognize the user as an authorized user.

Each time a payment request is made from the user device having the stored profile, user credentials stored in the profile are retrieved. The user credentials are used to authenticate the user and authorize the payment request. Thus, the user is not required to enter a username or password to authenticate his or her identity and to authorize payment.

In various embodiments, when the payment request is received, the software searches the user device for a user profile. If a user profile is detected, the software automatically presents the user with an option to make a payment with one or more funding sources. In one embodiment, the one or more funding sources are presented on a pop-up screen or window. In some embodiments, multiple buttons may be displayed for multiple funding sources. The user selects one or more funding sources, and payment is processed without the user having to log in to a separate site.

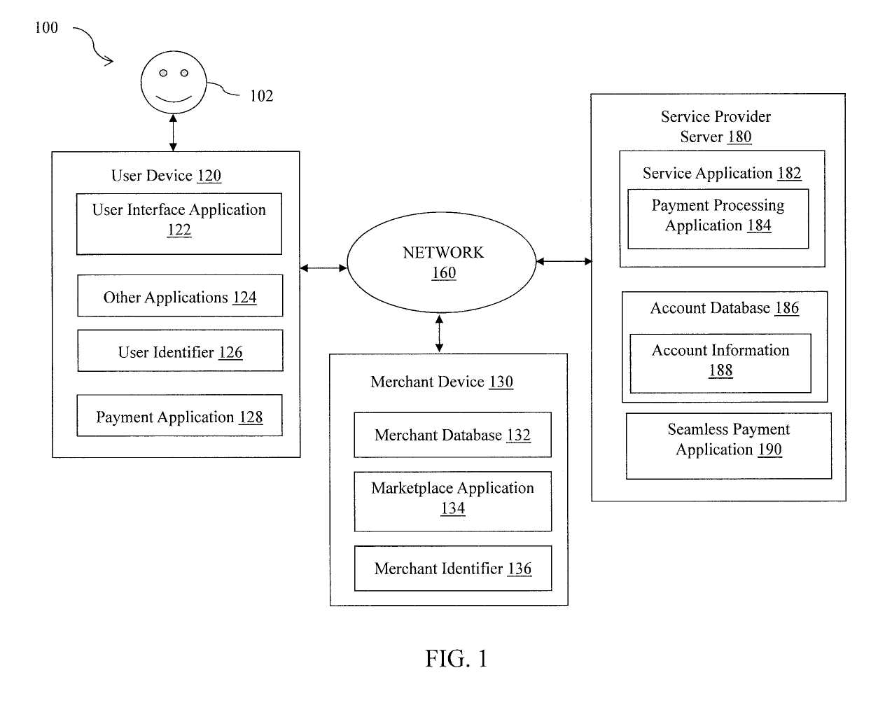

FIG. 1 shows one embodiment of a block diagram of a network-based system 100 adapted to facilitate payment with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 120, in one embodiment, may be utilized by the user 102 to interact with the merchant device 130 and/or the service provider server 180 over the network 160. For example, the user 102 may conduct financial transactions (e.g., account transfers) with the service provider server 180 via the user device 120. The user device 120, in various embodiments, may be implemented using any appropriate combination of hardware and/or software configured for wired and/or wireless communication over the network 160. In various implementations, the user device 120 includes a wireless telephone (e.g., cellular or mobile phone), a tablet, a personal computer, a notebook computer, a wearable computing device, and/or various other generally known types of wired and/or wireless computing devices.

The user device 120, in one embodiment, includes a user interface application 122, which may be utilized by the user 102 to conduct transactions (e.g., shopping, purchasing, bidding, etc.) with the merchant device 130 and/or service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The user device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

In various aspects, the user device 120 includes a component useful for biometric authentication, such as a camera, microphone, or scanner. The component is capable of capturing a person's unique human physiological or behavioral traits such as fingerprints, voice, face, iris, gait and signature. This authentication method provides a very high level of security. A user can be authenticated by comparing a stored characteristic to an obtained characteristic. If the characteristics match, the user is authenticated. By adding strong security to the user device 120, biometrics on the user device 120 facilitate trustworthy electronic methods for commerce and financial transactions.

In certain embodiments, the user device 120 includes a payment application 128. In one embodiment, a service provider distributes the payment application 128 to the user device 120 over the network 160. In some embodiments, the payment application 128 receives user information and creates a user profile containing the user information. The payment application 128 usually runs in the background, meaning that the application's activities are not visible to the user 102 and the application runs without user intervention.

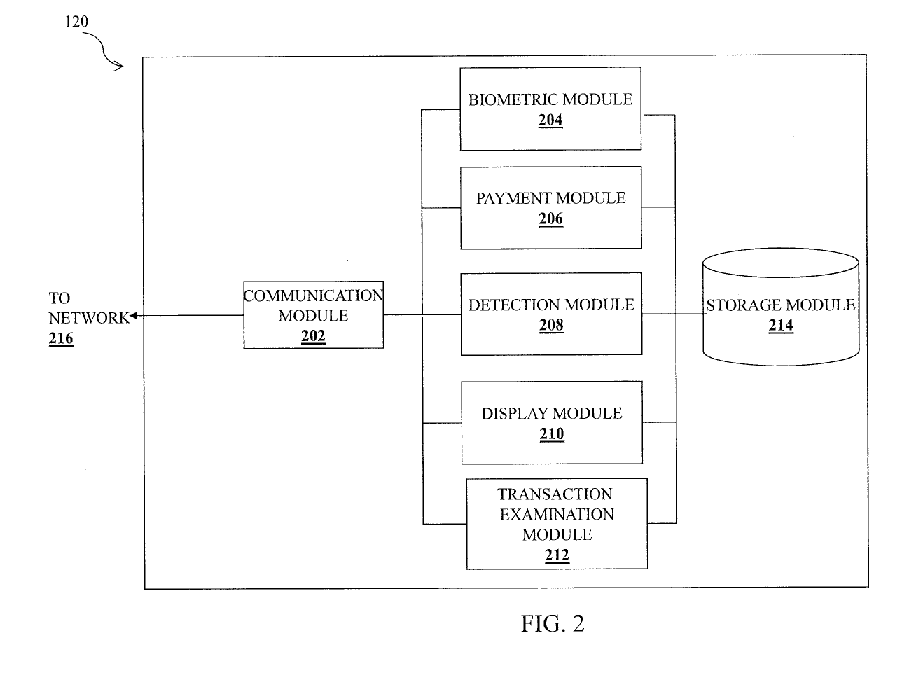

FIG. 2 illustrates an embodiment of a user device 120. The device 120 includes several components or modules, such as a communication module 202, biometric module 204, payment module 206, detection module 208, display module 210, transaction examination module 212, and storage module 214.

The device 120 includes a communication module 202 that is coupled to the network 216 and to any or all of a biometric module 204, payment module 206, detection module 208, display module 210, and transaction examination module 212, any of which may be coupled to a storage module 214. Any or all of the modules 202-212 may be implemented as a subsystem of the user device 120 including for example, a circuit, a hardware component, a hardware subcomponent, and/or a variety of other subsystems known in the art. Furthermore, any or all of the modules 202-212 may be preconfigured to perform their disclosed functionality, or may be configured by a processing system “on-the-fly” or as needed to perform their disclosed functionality. As such, any or all of the modules 202-212 may include pre-configured and dedicated circuits and/or hardware components of the user device 120, or may be circuits and/or hardware components that are configured as needed.

For example, any or all of the modules 202-212 may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that cause the modules 202-212 to perform the functions described below. As such, in some embodiments, preconfigured and dedicated circuits may be implemented to perform the functions of the modules 202-212. In other embodiments, a processing system may execute instructions on a non-transitory, computer-readable medium to configure one or more circuits as needed to perform the functions of the modules 202-212.

The communication module 202 may be included as a separate module provided in the device 120, or may be provided using instructions stored on a computer-readable medium that, when executed by a processing system in the device 120, configure the communication module 202 to send and receive information over the network 214, as well as provide any of the other functionality that is discussed herein. The biometric module 204 may be included as a separate module provided in the device 120, or may be provided using instructions stored on a computer-readable medium that, when executed by a processing system in the device 120, configure the biometric module 204 to receive biometric data from the user 102 and authenticate the user 102, as well as provide any of the other functionality that is discussed herein. In some embodiments, the biometric module 204 receives user profile information and generates a user profile from the information. The payment module 206 may be included as a separate module provided in the device 120, or may be provided using instructions stored on a computer-readable medium that, when executed by a processing system in the device 120, configure the payment module 206 to receive payment requests from the user 102, receive payment selections from the user 102, and communicate a selected payment option to the service provider server 180, as well as provide any of the other functionality that is discussed herein. The detection module 208 may be included as a separate module provided in the device 120, or may be provided using instructions stored on a computer-readable medium that, when executed by a processing system in the device 120, configure the detection module 208 to detect user profiles stored on the user device 120. The display module 210 may be included as a separate module provided in the device 120, or may be provided using instructions stored on a computer-readable medium that, when executed by a processing system in the device 120, configure the display module 210 to present payment options to the user 102. The transaction examination module 212 may be included as a separate module provided in the device 120, or may be provided using instructions stored on a computer-readable medium that, when executed by a processing system in the device 120, configure the transaction examination module 212 to evaluate the transaction. For example, the transaction examination module 212 checks purchase amounts, number of times a purchase has been made in a given time period, the total amount of purchases made in a given time period, identity of merchants, the location of user device 120, and identity of purchased items. Furthermore, other modules discussed above but not illustrated in FIG. 2 may be provided as separate modules on the device 120, or using instructions stored on a computer-readable medium similarly as discussed above. While the storage module 214 has been illustrated as located in the device 120, one of ordinary skill in the art will recognize that it may include multiple storage modules and may be connected to the modules 204-212 through the network 216 without departing from the scope of the present disclosure.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identifying available items, which may be made available to the user device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 136 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to a merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of the service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the user device 120 over the network 160 to facilitate the searching, selection, purchase, and/or payment of items by the user 102 from the one or more merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing module 184 settles indebtedness between the user 102 and each of the merchant servers 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and merchants. For example, account information 188 may include private financial information of user 102 and merchants (e.g., one or more merchants associated with merchant servers 130), such as one or more account numbers, passwords, credit card information, banking information, or other types of financial information, which may be used to facilitate financial transactions between user 102, and one or more merchants associated with the merchant servers 130. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes a seamless payment application 190. The seamless payment application 190 typically receives user information (e.g., username, password, funding sources, phone number, email, etc.) and generates a user profile that is stored on the user device 120. The user profile, and specifically the user credentials, can be retrieved by payment application 128 running on the user device 120 to facilitate seamless payments.

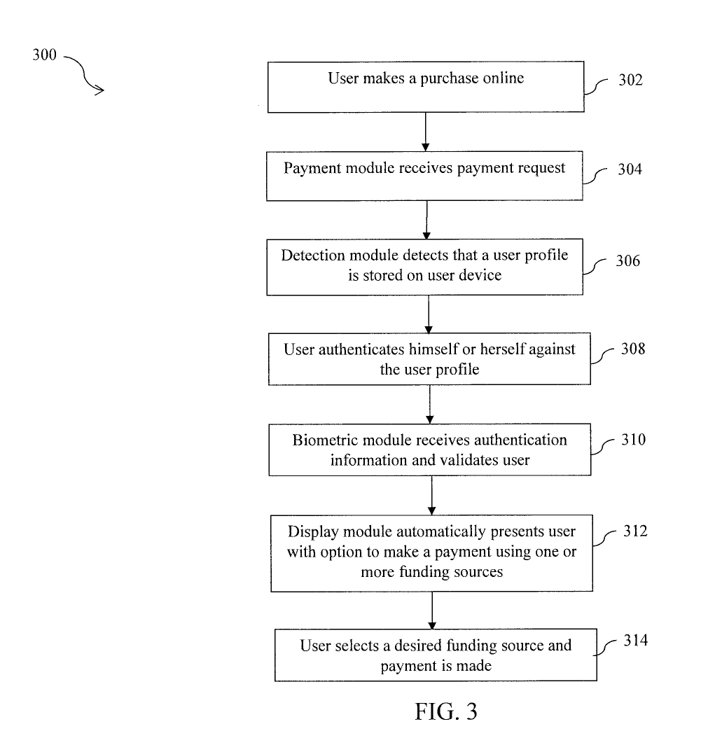

Referring now to FIG. 3, a flowchart 300 of a method for facilitating payment is illustrated according to an embodiment of the present disclosure. In various embodiments, the user 102 registers with a service provider. Registration may include signing up for the service and agreeing to any terms required by the service provider, such as through user device 120. In one embodiment, the user device 120 is a mobile computing device, such as a smart phone, a PC, or a computing tablet. In other embodiments, registration may be done completely through the user device 120, partially through the user device 120, or without using the user device 120, such as through a phone call or in-person visit to a representative of the service provider.

The user 102 may be requested to provide specific information for registration, such as, but not limited to, a name, address, phone number, email address, picture, biometric data (e.g., fingerprints, retina scan, etc.), available funding sources, a user name for the account, and a password or PIN for the account. The type of information requested may depend on whether the user 102 already has an account with the service provider. Requested information may be entered through the user device 120 or other means, including voice or manual key entry. Once all the requested information is received and confirmed, the service provider may create an account for the user.

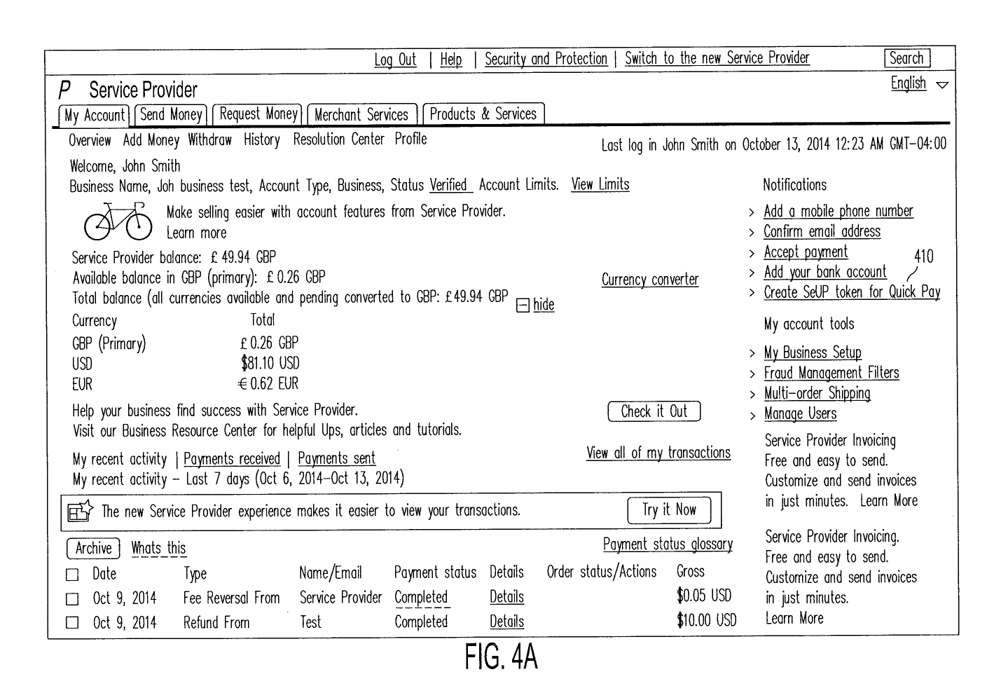

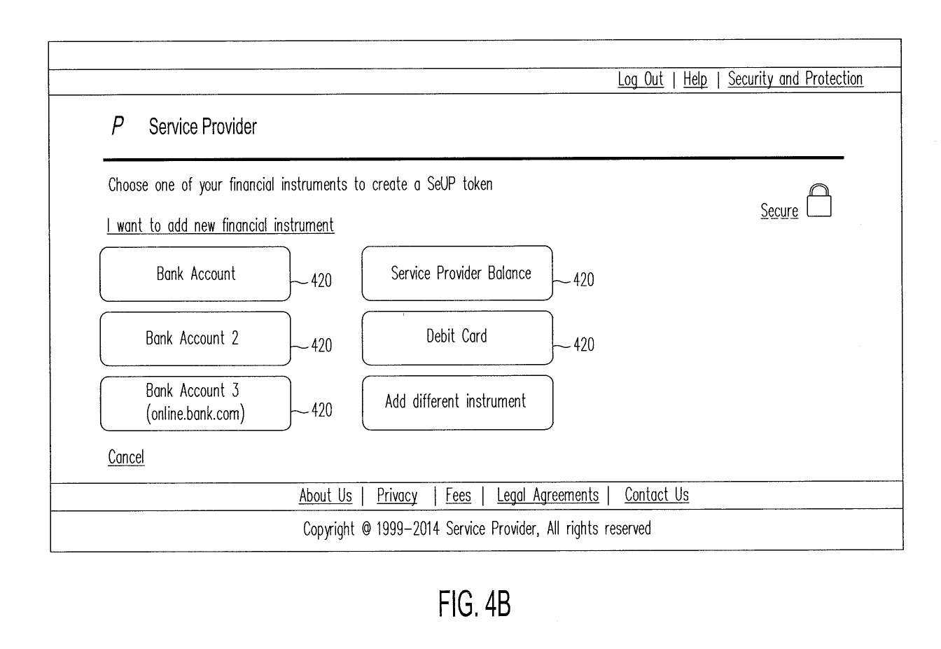

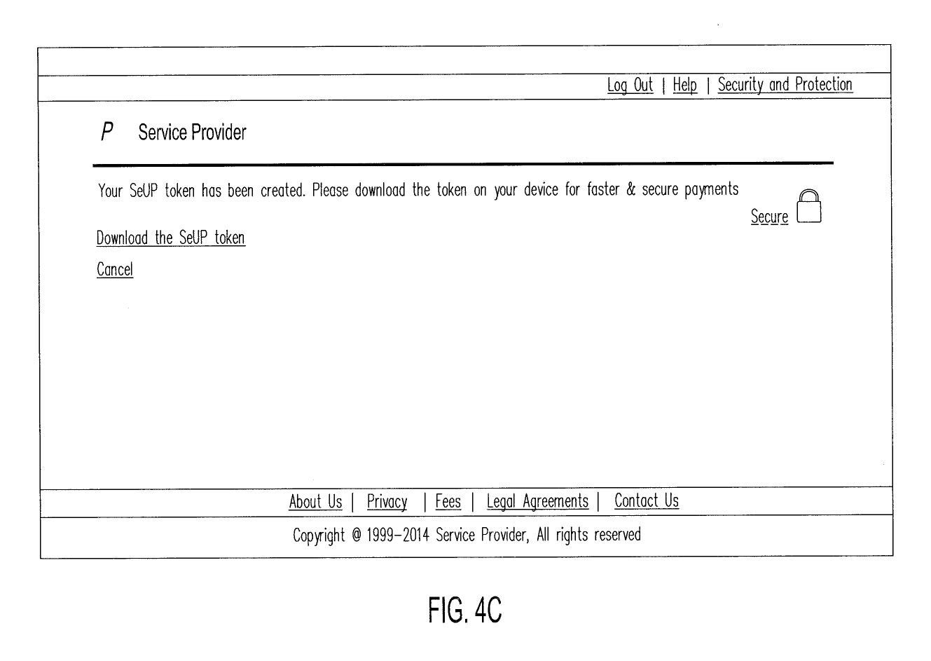

In some embodiments, the user 102 is asked if he or she wants to enable secure seamless payments. FIG. 4A is an example page that may be shown to user 102, including a link 410 to create a token for secure seamless payments. Should the user 102 decide that he or she wants to use this service, the service provider server 180 generates a profile for the user. The profile includes the user's credentials, including username, password, mobile number, PIN, etc.

The profile also includes one or more funding sources associated with the user 102. In some embodiments, the user 102 is requested to enter funding sources for the user account. FIG. 4B illustrates various funding sources or financial instruments 420 that may be selected by user 102. Funding sources include, for example, a credit card or debit card (e.g., Visa®, MasterCard®, Capital One®, Discover® or American Express® card, or), a bank account (e.g., Wells Fargo or Bank of America® checking account), a gift card (e.g., Wal-Mart gift card), prepaid card, line-of-credit, check, money order, etc. The user 102 has the option of adding further funding sources, or to edit or delete existing funding sources. In some embodiments, the user 102 selects a primary or default funding source. In certain embodiments, the user 102 creates a profile for each funding source. For example, the user can create a first profile for a Visa® credit card, a second profile for an American Express® credit card, and a third profile for a bank account.

The user profile is then stored locally on the user device 120 (e.g., in storage module 214) as, for example, an encrypted key. Encryption transforms the information in the user profile into a form that is non-readable to unauthorized parties. Encryption is well known in the art, and thus is not described in detail herein. In exemplary embodiments, Pretty Good Privacy (PGP) encryption is used to encrypt the profile. FIG. 4C shows a page that may be presented to user 102, where user 102 can download and store a token for secure payments.

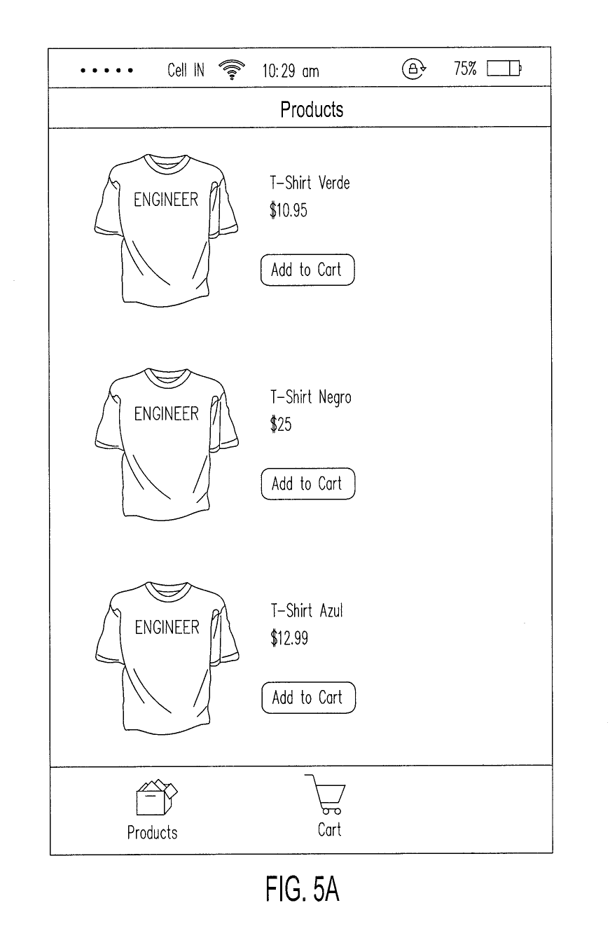

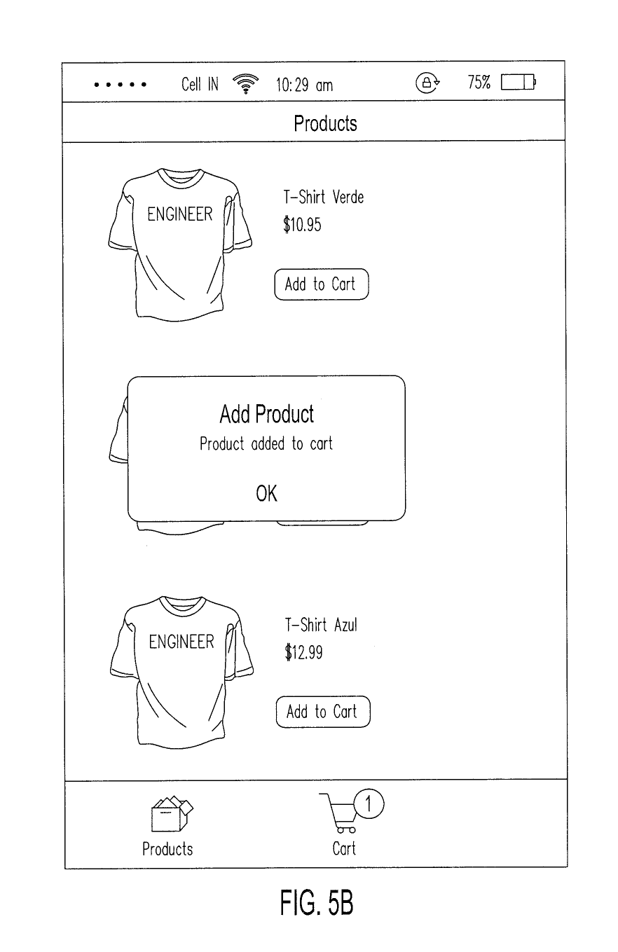

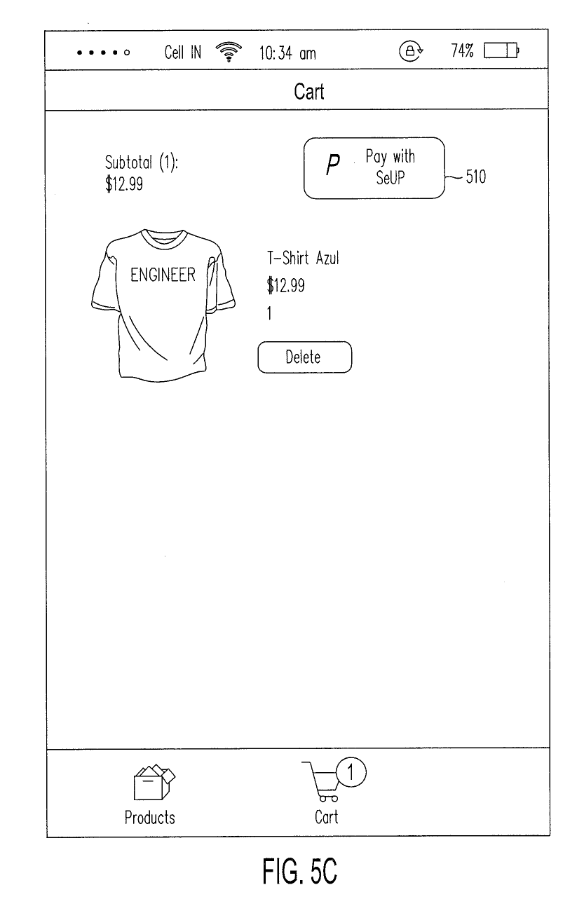

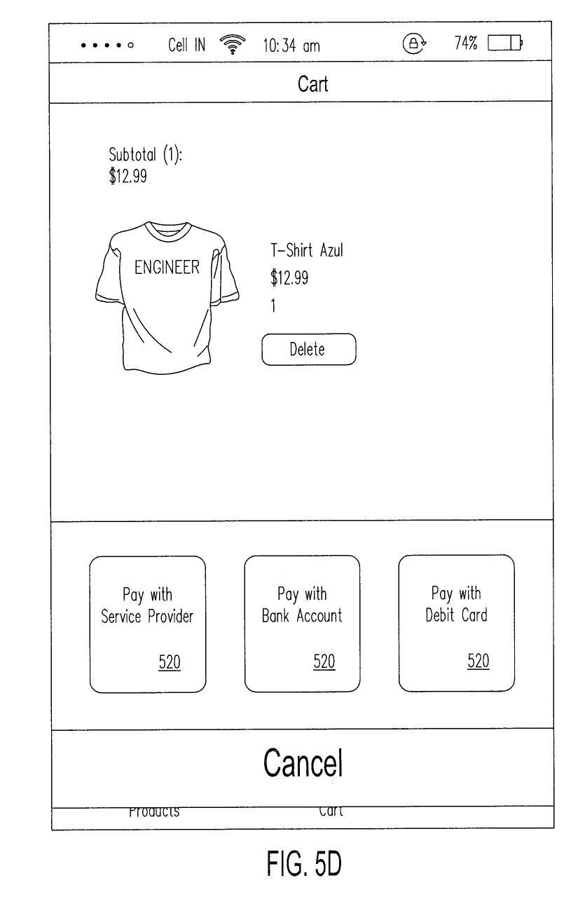

At step 302, the user 102 makes a purchase online and proceeds to checkout. For example, the user 102 clicks or otherwise selects “Pay” or “Make a Payment” on a merchant screen. FIG. 5A illustrates an example of a merchant screen where user 102 can select a t-shirt to purchase, and FIG. 5B shows that user 102 added a t-shirt to his or her cart.

At step 304, the payment module 206 of the user device 120 receives the payment request. In various embodiments, the payment request includes data and information related to the transaction including user information (e.g., user's name) and merchant information (e.g., merchant name, merchant account, merchant location, and one or more items selected for purchase including item description, category, price, weight, size, etc.).

In various embodiments, the transaction examination module 212 analyzes the details of the payment request to ensure that it is valid. The user 102, in some embodiments, may put restrictions on the use of seamless payments for security reasons. The restrictions may include a maximum amount per transaction, a maximum number of transactions per time period (e.g., week of month), a maximum dollar amount of transactions per time period, merchants that can be paid, items that can be paid for, and/or maximum amounts for transactions with a particular merchant. In some cases, the transaction examination module 212 determines the location of the user device 120, and if the location is a certain distance away from previous locations associated with the user 102, the transaction examination module 212 communicates to the payment module 206 that the payment request should be denied.

At step 306, the detection module 208 detects that a user profile is stored on the user device 120. For example, the detection module 208 searches the user device 120 for an appropriate token. In the case where there are multiple user profiles on the user device 120, the detection module 208 detects each of the multiple user profiles.

At step 308, the user 102 authenticates himself or herself against the user profile stored on the user device 120. For example, the user 102 can use his fingerprints, eyes or a pattern/gesture input into the user device 120 to prove his or her identity. A biometric trait can be used to authorize financial transactions without the user 102 having to enter a username or a password. In various embodiments, the biometric module 204 presents a user authentication screen on the user device 120 before the method proceeds.

At step 310, the biometric module 204 receives the authentication information and validates the user 102 against the user profile. For example, the biometric module 204 compares the received authentication information to stored information in the storage module 214. If the information matches, the user 102 is authenticated and allowed to proceed. If the information does not match, the user 102 is not allowed to proceed and may be prompted to re-enter authentication information.

At step 312, once the user 102 is validated by the biometric module 204, the display module 210 automatically presents the user 102 with the option to make a payment using one or more funding sources associated with the user profile(s). FIG. 5C shows a sample screenshot with a button 510 that user 102 can select to make a secure seamless payment. In other words, the display module 210 does not need the user 102 to enter any code or other information before the option is displayed to the user 102. There may be multiple buttons for multiple funding sources, with each button denoting a single funding source. In several exemplary embodiments, the payment module 206 removes any funding sources that are not accepted by the merchant so that the user 102 does not select such a funding source. FIG. 5D illustrates multiple funding sources 520 that user 102 can select to make the payment.

At step 314, the user 102 selects a desired payment button and payment is made. For example, the payment module 206 receives the selection and may communicate the selected payment choice to the service provider server 180. The service provider server 180 then processes the purchase using the selected funding source.

In some embodiments, the user 102 selects more than one payment button to select more than one funding source. After the user 102 selects a payment button, he or she can designate the amount to be deducted or charged to that funding source. The user 102 can then select another payment button and designate another amount to be deducted or charged to the second funding source.

In various embodiments, payment can be made without selection of a funding source by the user 102. In one embodiment, the user's profile includes only one funding source so the user 102 is not required to choose a funding source. The one funding source is automatically used to pay for the purchase. In other embodiments, the user 102 may have previously provided preferences for a funding source or funding sources to be used in specific situations. For example, the user 102 can select a funding source(s) to be used for every transaction, for certain transaction amounts, and/or for certain merchants. In these cases, the user 102 simply selects the option to make a payment using a funding source associated with his or her profile, and payment is automatically made using the user's preferred funding source(s) for that specific transaction. In another embodiment, the user 102 may be asked to confirm the payment amount and funding source first before payment is made.

The present disclosure describes systems and methods that facilitate secure seamless payments. A user profile is created and stored on a user device. When the user encounters a screen or website where payment is to be made, user credentials are retrieved from the user profile on the user device. The user simply provides a biometric trait, and software running in the background of the user device validates the user to authorize payment.

Advantageously, the user is not required to type in any information, such as a username, password, or any type of code. The user is not navigated away from the merchant page or website, and is not required to log in to a payment provider site for payment. The payment application on the user device executes in-line payments without being redirected to a third party payment provider. Moreover, the user profile can be shared across various third party applications. Third party applications can use these APIs to make seamlessly fast payments without redirecting the user to enhance the user experience.

### Examples

Particular examples will now be described. A user logs on to her personal computer and a Norton™ antivirus update pops up. The update requires payment. Since the user's profile (including username and password) is already stored on the personal computer, the user simply authenticates herself using her voice. Payment is processed without the user having to log in to a payment provider website.

A user is playing Temple Run on his mobile device. While playing, the user runs out of chances, and he is given an option to purchase an extra life for $0.99. The user selects the option. After authenticating himself by providing a fingerprint, he is presented with multiple funding sources to pay for the extra life. The user selects one or more funding sources, gets the extra life, and continues playing the game without leaving the game application, which enhances the user experience.

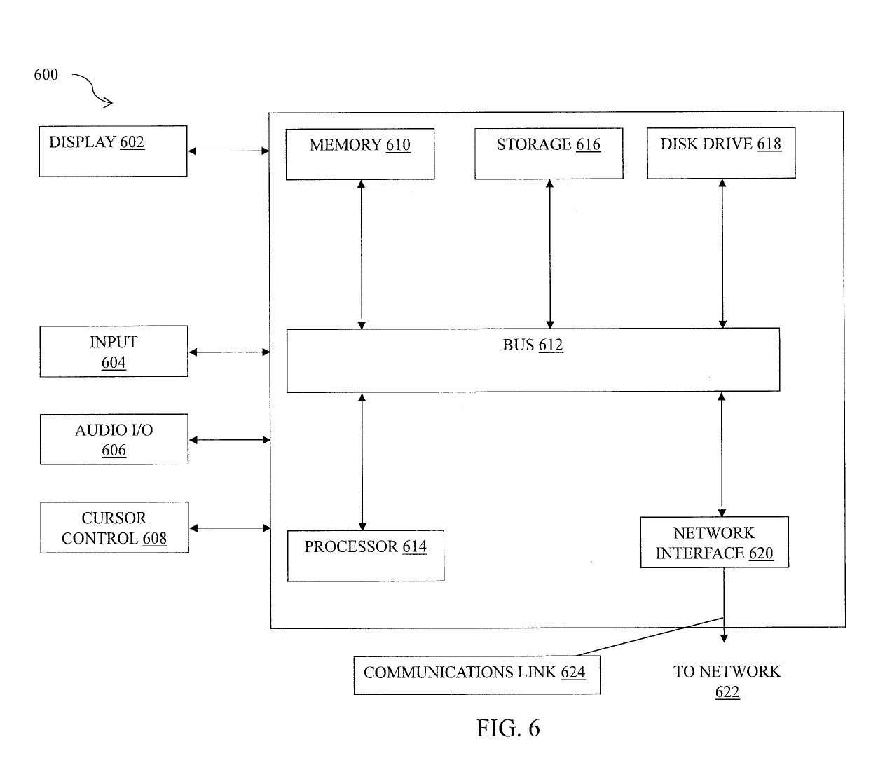

FIG. 6 is a block diagram of a computer system 600 suitable for implementing one or more embodiments of the present disclosure, including the user device 120, merchant server 130, and the service provider server 180. In various implementations, the user device 120 may comprise a mobile cellular phone, personal computer (PC), laptop, wearable computing device, etc. adapted for wireless communication, and the merchant server 130 and service provider server 180 may comprise a network computing device, such as a server. Thus, it should be appreciated that the devices 120, 130, and 180 may be implemented as computer system 600 in a manner as follows.

Computer system 600 includes a bus 612 or other communication mechanism for communicating information data, signals, and information between various components of computer system 600. Components include an input/output (I/O) component 604 that processes a user (i.e., sender, recipient, service provider) action, such as selecting keys from a keypad/keyboard, selecting one or more buttons or links, etc., and sends a corresponding signal to bus 612. I/O component 604 may also include an output component, such as a display 602 and a cursor control 608 (such as a keyboard, keypad, mouse, etc.). An optional audio input/output component 606 may also be included to allow a user to use voice for inputting information by converting audio signals. Audio I/O component 606 may allow the user to hear audio. A transceiver or network interface 620 transmits and receives signals between computer system 600 and other devices, such as another user device, a merchant server, or a service provider server via network 622. In one embodiment, the transmission is wireless, although other transmission mediums and methods may also be suitable. A processor 614, which can be a micro-controller, digital signal processor (DSP), or other processing component, processes these various signals, such as for display on computer system 600 or transmission to other devices via a communication link 624. Processor 614 may also control transmission of information, such as cookies or IP addresses, to other devices.

Components of computer system 600 also include a system memory component 610 (e.g., RAM), a static storage component 616 (e.g., ROM), and/or a disk drive 618. Computer system 600 performs specific operations by processor 614 and other components by executing one or more sequences of instructions contained in system memory component 610. For example, processor 614 can receive payment requests, detect that a user profile is stored on a user device, receive authentication information from a user, and automatically present a user with an option to make a payment using one or more funding sources. Logic may be encoded in a computer readable medium, which may refer to any medium that participates in providing instructions to processor 614 for execution. Such a medium may take many forms, including but not limited to, non-volatile media, volatile media, and transmission media. In various implementations, non-volatile media includes optical or magnetic disks, volatile media includes dynamic memory, such as system memory component 610, and transmission media includes coaxial cables, copper wire, and fiber optics, including wires that comprise bus 612. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a storage module that stores user profile information;
a payment module that receives a payment request on a merchant screen from a user on a user device;
a detection module that detects at least one user profile stored on the user device;
a biometric module that receives biometric information from the user and validates the user against the stored user profile; and
a display module that automatically presents the user with one or more funding sources associated with the user profile for payment when the user is validated.

2. The system of claim 1, wherein the payment module further receives a selected funding source from the user and communicates the selected funding source to a service provider.

3. The system of claim 2, wherein the payment module further receives more than one selected funding source and designated amounts to be charged or deducted from each funding source.

4. The system of claim 1, wherein the payment module further removes one or more funding sources that are unacceptable for payment.

5. The system of claim 1, wherein the display module presents the one or more funding sources on a pop-up screen.

6. The system of claim 5, wherein the display module does not redirect the user to another website after a funding source on the pop-up screen is selected.

7. The system of claim 1, wherein the user profile comprises user credentials.

8. The system of claim 1, wherein the user profile is stored as an encrypted key.

9. The system of claim 1, further comprising a transaction examination module that analyzes the details of the payment request to ensure that the payment request is valid.

10. A method for facilitating payment, comprising:
receiving, by a processor of a user device, a payment request on a merchant page from a user on a user device;
searching, by the processor, the user device for at least one token corresponding to a user profile;
validating, by the processor, the user by comparing received biometric information with stored biometric information associated with the user profile; and
automatically presenting, by the processor, on the user device, an option to make a payment with one or more funding sources associated with the user profile when the user is authenticated.

11. The method of claim 10, wherein the user is not navigated away from the merchant page when selecting a funding source.

12. The method of claim 10, wherein the one or more funding sources are presented on a pop-up screen.

13. The method of claim 10, wherein the user profile comprises user credentials.

14. The method of claim 13, further comprising retrieving the user credentials to authenticate the user.

15. A non-transitory machine-readable medium comprising instructions which, in response to execution by a computer system, cause the computer system to:
configure a payment circuit to receive a payment request on a merchant screen from a user on a user device;
configure a detection circuit to detect a user profile stored on the user device;
configure a biometric circuit to receive biometric information on the user device and authenticate the user against the user profile based on the received biometric information; and
configure a display circuit to automatically display a screen having one or more funding sources associated with the user profile when the user is authenticated.

16. The non-transitory machine-readable medium of claim 15, wherein the instructions, in response to execution by the computer system, further cause the computer system to configure the payment circuit to receive a selected funding source and communicate the selected funding source to a service provider.

17. The non-transitory machine-readable medium of claim 16, wherein the service provider processes payment using the selected funding source.

18. The non-transitory machine-readable medium of claim 15, wherein the instructions, in response to execution by the computer system, further cause the computer system to configure the biometric module to receive user information and generate the user profile.

19. The non-transitory machine-readable medium of claim 18, wherein the user information comprises user credentials and funding source information.

20. The non-transitory machine-readable medium of claim 15, wherein the user profile is stored as an encrypted key.
